(19) United States
(12) Patent Application Publication
(10) Pub. No.: US 2026/0142384 A1
(43) Pub. Date: May 21, 2026

(54) UNIVERSAL CONNECTOR

(71) Applicant: IDEAL Industries, Inc., Sycamore, IL (US)

(72) Inventors: Douglas A. Sanford, Sycamore, IL (US); Sushil N. Keswani, Sycamore, IL (US)

(21) Appl. No.: 19/122,469

(22) PCT Filed: Oct. 23, 2023
(86) PCT No.: PCT/US2023/077532

§ 371 Date: Apr. 18, 2025

Related U.S. Application Data
(60) Provisional application No. 63/418,074, filed on Oct. 21, 2022.

(51) Int. Cl. H01R 4/18

(52) U.S. Cl. CPC H01R 4/183

(57) ABSTRACT

Systems, apparatuses, and methods are described for universal electrical connection. Each universal electrical connector may connect to a plurality of other identical universal electrical connectors. Conductors may be physically and electrically attached to each universal electrical connector. Accordingly, the universal electrical connector may electrically connect any number of conductors (e.g., wires) using multiple identical universal electrical connectors.

### CROSS REFERENCE TO RELATED APPLICATION

This application is a non-provisional application claiming priority from U.S. Provisional Application Ser. No. 63/418,074, filed Oct. 21, 2022, and incorporated herein by reference in its entirety.

### FIELD OF THE DISCLOSURE

The present description relates generally to connectors for electrical components and more particularly to a universal connector.

### BACKGROUND OF RELATED ART

Electrical wire connectors electrically connect components in all modern buildings and are ubiquitous with modern electricity. Different methods exist to connect electrical wires, cables, and/or electrical components. Present solutions for wire connections often require different parts for connections of differing numbers. For example, a connection of two wires may require one part while a connection of four wires may require a different part. Thus, manufacturers produce, and installers must maintain many different parts for connection. Additionally, many present forms of electrical connection render it dangerous to connect and/or disconnect charged/energized wires.

In one example of a multi-wire connector, U.S. Pat. No. 7,507,106 describes a push-in wire connector that has a busbar suitable for use with either solid or stranded wire. The connector has a housing with a hollow interior and at least two openings in the housing provide access to the interior for the ends of wires inserted into the connector. A busbar is mounted in the housing. The busbar defines at least two wire-crossing axes extending from an entry edge to an exit edge and a thickness between a top face and a bottom face. The busbar has a wire-receiving pocket extending below the top face on each of the wire-crossing axes and a wire-engaging protrusion extending above the top face on each of the wire-crossing axes.

The present disclosure provides for improvements in the art.

### SUMMARY

The following summary presents a simplified summary of certain features. The summary is not an extensive overview and is not intended to identify key or critical elements.

Systems, apparatuses, and methods are described for universal electrical connectors. Each universal electrical connector may physically and electrically connect to a conductor (e.g., wire). Each universal electrical connector may be physically connected to two other identical universal electrical connectors. Accordingly, a chain of universal electrical connectors may be installed together to effectuate the electrical connection of any number of a plurality of electrical conductors. Additionally, such connection of any number of a plurality of conductors may be achieved with a plurality of identical electrical connectors.

In some aspects, the techniques described herein relate to an electrical connector including: a conductive body including: a stem; and a first contact and a second contact extending from the stem, the first contact configured to electrically contact a first different contact of a first another electrical connector, and the second contact configured to electrically contact a second different contact of a second another electrical connector; and a housing including an insulating material and being configured to enclose at least a portion of the conductive body and to electrically insulate the enclosed portion of the conductive body such that the electrical connector is configured to be installed and detached from the another electrical connector even while electric charge is present.

In some aspects, the techniques described herein relate to a universal connector system including: a first electrical connector including: a first conductive body including: a first stem; a first contact extending from the first stem at a first end thereof and proximate to a first side thereof; and a second contact extending from the first stem at the first end thereof and proximate to a second side thereof substantially opposed to the first side thereof; and a first insulator housing enclosing a portion of the first conductive body and configured to engage at least one other housing; and a second electrical connector substantially identical to the first electrical connector including: a second conductive body including: a second stem; a third contact extending from the second stem at a first end thereof and proximate to a first side thereof such that when the first electrical connector and second electrical connector are installed together, the first contact electrically contacts the third contact effecting an electrical connection between the first conductive body and second conductive body; and a fourth contact extending from the second stem at the first end thereof and proximate to a second side thereof substantially opposed to the first side thereof; and a second insulator housing enclosing at least a portion of the second conductive body and configured to such that when the first electrical connector and the second electrical connector are installed together, the first insulator housing engages the second insulator housing.

In some aspects, the techniques described herein relate to a universal connector system including: a plurality of substantially identical electrical connectors engaged with each other, each of the plurality of substantially identical electrical connectors configured to engage with and electrically connect to a first engaged electrical connector and a second engaged electrical connector, each of the plurality of substantially identical connectors including: a conductive body including: a stem; a first contact extending from a first end of the stem and configured to electrically contact a first another contact of the first engaged electrical connector; and a second contact extending from the first end of the stem and configured to electrically contact a second another contact of the second engaged electrical connector; and a housing enclosing at least a portion of the conductive body.

In some aspects, the techniques described herein relate to an electrical connector including: a conductive body including: a stem; and a first contact and a second contact extending from the stem, the first contact being mechanically configured to be a plug and to contact a first different contact of a first another electrical connector, the second contact being mechanically configured to be a socket of complementary configuration to the plug and to electrically contact a second different contact of a second another electrical connector; and a housing including an insulating material, the housing being configured to enclose at least a portion of the conductive body and electrically insulate the enclosed portion of the conductive body such that the electrical connector is configured to be installed and detached from the first another electrical connector even while electrical charge is present.

### BRIEF DESCRIPTION OF THE DRAWINGS

FIG. 1 illustrates an example electrical connector according to the present disclosure.

FIG. 2 illustrates a partial view of three example conductive bodies of the example electrical connectors of FIG. 1 in contact with one another.

FIG. 3 illustrates a transparent housing view of an example installation of three example electrical connectors of FIG. 1.

FIG. 4 illustrates a perspective view of two example electrical connectors of FIG. 1 as installed with one another.

FIG. 5 illustrates a transparent housing view of another example installation of a plurality of example electrical connectors with electrical wires attached thereto.

FIG. 6 illustrates an example conductive body for use in the example electrical connector of FIG. 1.

FIG. 7 illustrates a perspective view of another example installation of a plurality of example electrical connectors of FIG. 1 with electrical wires attached thereto.

FIG. 8 illustrates another perspective view of the example installation of a plurality of example electrical connectors of FIG. 7.

FIG. 9 illustrates a side elevational view of the example installation of a plurality of example electrical connectors of FIG. 7.

FIG. 10 illustrates a bottom plan view of the example electrical connector of FIG. 1.

FIG. 11 illustrates a top plan view of the example electrical connector of FIG. 1.

FIG. 12 illustrates another side elevational view of the example electrical connector of FIG. 1.

FIG. 13 illustrates another side elevational view of the example electrical connector of FIG. 1.

FIG. 14 illustrates a perspective view of the example electrical connector of FIG. 1.

FIG. 15 illustrates a perspective view of the example electrical connector of FIG. 1.

FIG. 16 illustrates a bottom perspective view of an assembly of an example conductive body and an example housing stem of FIG. 15.

FIG. 17 illustrates another example of an assembly of example electrical connectors with an illustrated transparent housing similar to FIG. 5.

FIG. 18 illustrates the example assembly of FIG. 17 with the housing being opaque.

FIG. 19 illustrates a bottom perspective view of one of the example electrical connectors of FIG. 17.

FIG. 20 illustrates an example conductive body for use with the example electrical connector of FIG. 17.

FIG. 21 illustrates another view of the example conductive body of FIG. 20.

FIG. 22 illustrates another view of the example conductive body of FIG. 20.

FIG. 23 illustrates another view of the example conductive body of FIG. 20.

FIG. 24 illustrates another example electrical connector coupling mechanism showing four coupled connectors.

FIG. 25 illustrates another view of the example electrical connector of FIG. 24 showing two coupled connectors.

### DETAILED DESCRIPTION

The following description of example methods and apparatus is not intended to limit the scope of the description to the precise form or forms detailed herein. Instead, the following description is intended to be illustrative so that others may follow its teachings.

Systems, apparatuses, and methods are disclosed for universal electrical connectors. In the disclosed examples, each universal electrical connector physically and electrically connects to a conductor, such as a wire or other suitable conductor. In operation, each universal electrical connector may be physically connected to two other identical, or matingly compatible universal electrical connectors. Accordingly, a chain of universal electrical connectors may be installed together to effectuate the electrical connection of any number of a plurality of electrical conductors. Additionally, such connection of any number of a plurality of conductors may be achieved with a plurality of identical electrical connectors.

The following is a disclosure of examples of a universal electrical connector. Oftentimes, electrical wires require connection to each other and/or to various devices/appliances. For example, in buildings (e.g., homes, commercial buildings, etc.), electrical wires often route through the framing of the building and terminate in electrical boxes (e.g., gang or junction boxes). In the electrical boxes, the electrical wires may be connected with each other to an electrical appliance (e.g., outlet, light, light switch, etc.) and/or to wires from an electrical appliance. Depending on the application, different numbers of multiple wires often require connection.

Currently, a number of solutions to wire various connections exist. For example, one method of connection may be by applying a wire-nut connector via twisting onto a grouping of wires. However, a disadvantage of wire-nut connectors is the need for different-sized wire-nuts depending on the number of wires to be joined. Additionally, it may be dangerous to connect and/or disconnect wire nuts while the conductors which they are connecting are energized. Alternative solutions include push-in connectors or other similar connectors having a dedicated number of ports for the number of wires to be connected. With these connectors, each wire to be joined is installed (e.g., with a lever, screw, etc.) in a dedicated port, and contact is made by a conductive body between all of the ports. As with the wire-nut connector, push-in connectors are associated with disadvantages for the manufacturer and the installer. For example, different push-in connectors may need to be used depending on the number of wires being connected. Therefore, the manufacturer requires many different parts, each with dedicated tooling. Similarly, the installer requires many different connectors of different sizes (e.g., having a different number of ports). Additionally, like wire nuts, it may be dangerous to connect and/or disconnect energized wires with push-in connectors.

Accordingly, the example electrical connectors of the present disclosure may achieve multiple advantages. For example, the electrical connectors of the present disclosure can be electrically connected to any number of additional electrical connectors, obviating the need for different connectors based on connection number. Further, the electrical connector of the present disclosure can be installed and detached from other connectors with increased safety, even while electrically energized. Further still, the electrical connectors of the present disclosure achieve these advantages with a single connector. Identical connectors may be used to electrically connect any number of wires. Accordingly, manufacturers may only produce a single connector (which may include multiple parts that may be identical to the parts of other connectors), and installers may only use a single connector.

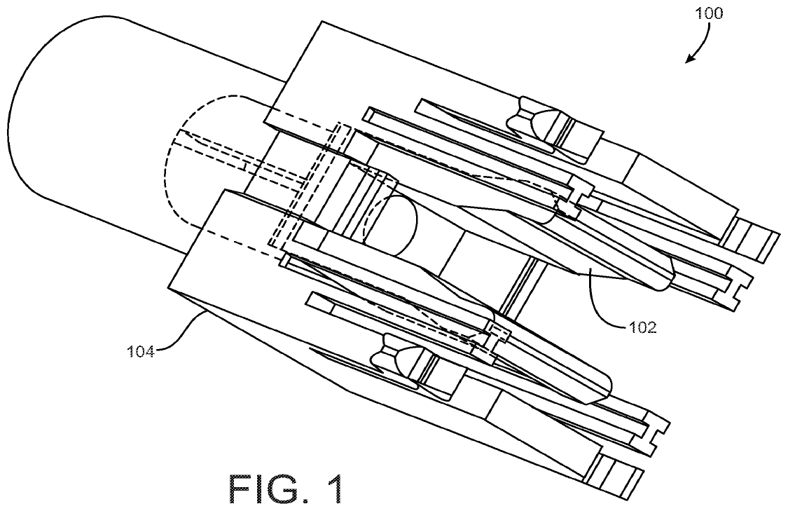

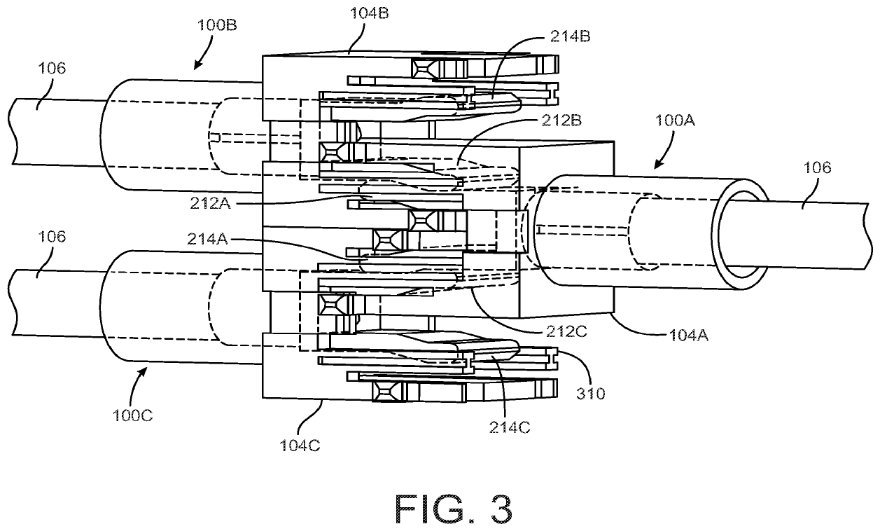

Referring generally to FIGS. 1-4 and specifically to FIG. 1, there is illustrated an example electrical connector 100 according to one or more aspects of the present disclosure. The example electrical connector 100 comprises a conductive body 102 and a housing 104. The housing 104 in FIG. 1, is illustrated as being transparent for ease of illustration and understanding, but it will be understood that the example housing 104 may be any suitable housing material, including an opaque non-conductive material, such as plastic or similar material. In this example, the conductive body 102 is suitably physically fixed to and electrically connected to a conductor (e.g., an electrical wire 106 as shown in FIG. 3). The housing 104 encloses at least a portion of the conductive body 102. As will be appreciated, the housing 104 electrically insulates the enclosed portion of the conductive body 102 from the surroundings of the electrical connector 100.

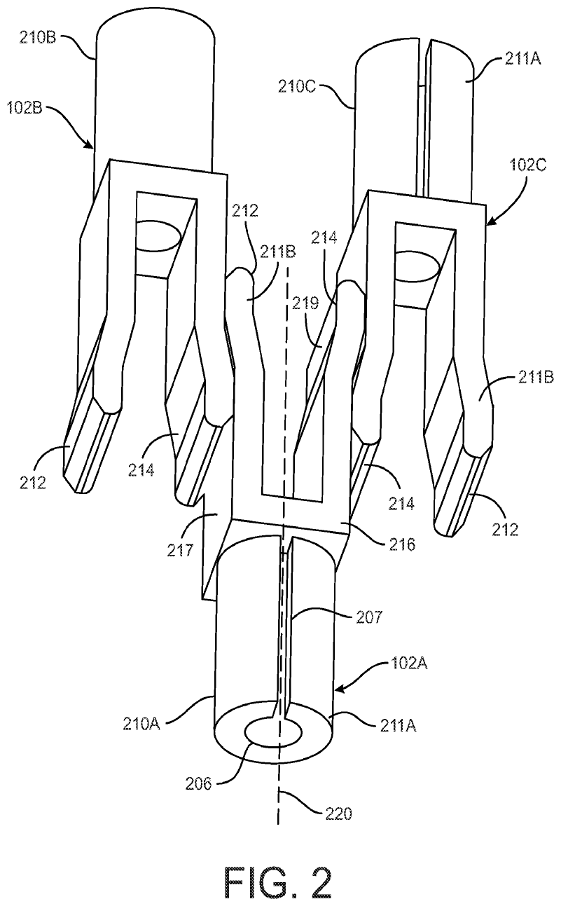

FIG. 2 illustrates three example conductive bodies 102A, 102B, and 102C (generally, “conductive body 102” or “conductive bodies 102”) in contact according to one or more aspects of the present disclosure. The conductive bodies 102 of FIG. 2 are illustrated without their respective housing 104 for ease of illustration and understanding. It should be understood that in use, the conductive bodies 102 of FIG. 2 may be surrounded on at least some sides and/or partially enclosed by the housing 104 or other suitable housing or enclosure as desired. Still referring to FIG. 2, each conductive body 102 may be substantially identical or otherwise matingly compatible to one another.

In this example, the conductive body 102 is constructed out of a conductive material, for example, a metal (e.g., copper, aluminum, steel, brass, gold, etc.), or other suitable conductor. The example conductive bodies 102 include a stem 210A, a stem 210B, and a stem 210C (generally a stem 210) which in this instance are each configured and adapted to mate with the electrical wire 106. The example stem 210 is round, but may be any other suitable shape as desired including being a flat plate, or other connector type. The example stem 210 also includes a first end 211A and a second end 211B. The example stem 210 is generally cylindrical about a longitudinal axis, but the shape may be any other extrusion of a native shape. Further, as illustrated, the example stem 210 includes an orifice 206 or other defined opening. In this instance, the orifice 206 is mechanically configured to receive and be connected to the electrical wire 106. Accordingly, the electrical connector 100 may be connected to (i.e., physically attached to and electrically connected with) an electrical conductor.

For instance, in operation, an electrical conductor such as the electrical wire 106 is inserted into, or otherwise matingly coupled to the stem 210. For example, the stem 210 may be crimped onto the electrical wire 106 (e.g., with the use of a crimping tool) or may be held onto the electrical wire 106 by any suitable method, including for instance a push-in type contact element. In one example, the stem 210 includes a slit 207 to facilitate expansion of the orifice 206 and/or to assist in crimping of the stem 210 to the electrical wire 106. Additionally or alternatively, the stem 210 may be soldered, welded, press connected, fastened, attached using an insulation displacement element or otherwise engaged with the electrical wire 106.

As further illustrated in FIG. 2, each example conductive body 102A, 102B, 102C comprise two contacts, namely a first contact 212 and a second contact 214. In this example, there is no structural difference between the first contact 212 and the second contact 214, but it will be understood that the contacts may be different and configured for various mating relationships, such as for instance having a male profile and a female profile or other suitable variation. In embodiment, the first contact 212 and the second contact 214 extend from the stem 210 along a center plane 220. As illustrated in this example, each of the conductive bodies 102 generally form a wishbone or y-type overall shape, where the first contact 212 and the second contact 214 each extend from the same first end of the stem 210. For example, as shown, the first contact 212 and the second contact 214 each extend distally from the stem 210 and generally in the same direction as one another. It will be understood that various other arrangements of the contacts may be utilized, including having contacts extending in different directions as needed.

The example first contact 212 and the example second contact 214 are substantially identical to each other in shape and size as well. Accordingly, in this example the first contact 212 and the second contact 214 are understood to be mirrored about the center plane 220 (e.g., sagittal plane) (shown in FIG. 2 as a dashed line for clarity of illustration and example) that divides the conductive body 102 and separates the first contact 212 and the second contact 214.

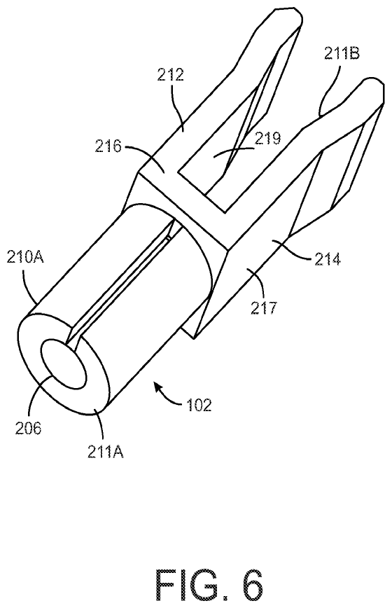

Continuing on, each of the example first contact 212 and the example second contact 214 has a lateral side 217 and a medial side 219 (see also FIG. 6). The medial side 219 is understood as the side closest to the center plane 220 (i.e., the inside), and the lateral side 217 may be understood as the side farther from the center plane 220.

The example conductive body 102 also includes a laterally biased portion 216, which in this instance couples the first contact 212 and the second contact 214 to the stem 210. The example laterally biased portion 216 includes a portion of the length of the first contact 212 and the second contact 214 and extends and/or protrudes in a lateral direction, such as perpendicular to the center plane 220. Alternatively, each of the first contact 212 and the second contact 214 includes a medially biased portion. When utilized, the medially biased portion includes a portion of the length of the first contact 212 and the second contact 214 and extends and/or protrudes in the medial direction, such as along the center plane 220.

As illustrated in at least FIG. 3, in use, two or more electrical connectors 100 may be connected with each other. For instance, the conductive body 102A may be installed with and electrically connected to conductive body 102B and conductive body 102C. As shown, a first contact 212A of the conductive body 102A and a second contact 214A of the conductive body 102A is directly physically touching (e.g., contacting) a respective contact from a first adjacent installed electrical connector 100B and, possibly, a second contact from a second adjacent installed electrical connector 100C. More particularly, conductive bodies 102A, 102B, and 102C may be installed such that each of the conductive bodies 102A, 102B, and 102C are in physical and/or electrical contact with each other.

More precisely, as illustrated, the first contact 212A of the conductive body 102A is physically touching (e.g., contacting, abutting, pressing against) a first contact 212B of the conductive body 102B. Similarly, the second contact 214B is physically touching a first contact 212C of the conductive body 102C. Accordingly, when installed in this manner, the conductive bodies 102A, 102B, and 102C are electrically connected to one another. It should be noted that the conductive bodies 102B and 102C may be electrically connected to each other even though the conductive bodies 102B and 102C may not physically contact each other. According to this scheme, as may be appreciated, additional connectors may be installed and added to the chain (e.g., an additional connector installed to the conductive body 102B and an additional connector installed to the conductive body 102C). All connectors installed in this chain may be electrically connected with each other. Additionally, as may be appreciated, each conductive body may be attached to a conductor (e.g., the electrical wire 106). Accordingly, a chain of conductive bodies 102 (i.e., electrical connectors 100) may effectively electrically connect all electrical wires 106 attached to the respective conductive bodies 102 of the chain.

As noted above, FIG. 3 illustrates an example installation of three electrical connectors 100 according to one or more aspects of the present disclosure. Each of the housings 104 are again illustrated as being transparent in FIG. 3 for ease of illustration and understanding. As installed, the housings 104 of two installed electrical connectors 100 engage each other. In this example, the housings 104 each include a guide 310 (e.g., tracks, rails, etc.) wherein the guide 310 of a first installed housing 104A engages with and fits into the guide 310 of a second installed housing 104B. Accordingly, the guide 310 and, at times, sides of the housings 104 may act as retention features (e.g., lateral retention feature, etc.). Such lateral retention feature may restrict the relative motion between the two installed electrical connectors in the transverse direction (e.g., motion parallel with the transverse plane) and opposing direction.

In addition, the guide 310 may include, for example, tracks of opposing complementary geometry (e.g., plug/socket, male/female) geometries. Alternatively, the guide 310 may be hermaphroditic. Accordingly, each of the guides 310 may be the same on all sides with hermaphroditic blades and receptacles. The hermaphroditic connector may mate and demate to itself, enabling a lower part numbers inventory.

With continued reference to FIG. 3, as disclosed, if installed, the guides 310 of two installed housings 104 may engage and may restrict the relative movement of the two installed electrical connectors 100 in particular directions (e.g., the transverse and/or opposite directions). As illustrated the lateral side of the first contact 212A of the first electrical connector 100A contacts the lateral side of the first contact 212B of the second electrical connector 100B. Due to the lateral bias of the contacts 208, as the connectors 100 are installed, the contacts may interfere with each other. The contacts may move or be displaced, in the medial direction, away from their natural resting position as a consequence of interfering with the mating contact. Accordingly, each contact may impose a restorative force to restore the contact to its resting position. Due to this restorative force, the installed contacts 212A and 212B may remain in physical and electrical contact while installed. The housing guides and/or the housing sides may similarly oppose the restorative force of the contacts, assisting in the perpetual touching (e.g., contact) of the installed contacts 212A and 212B. Accordingly, two installed contacts may be understood to wipe against each other upon installation, to displace each other based on the wiping contact, and to remain displaced while installed, assisting in electrical contact. Further, accordingly, the touching faces of the installed contacts 212A and 212B (i.e., lateral sides) may be broad enough such that the contacting surface area is sufficient to carry the desired current without unacceptable resistance.

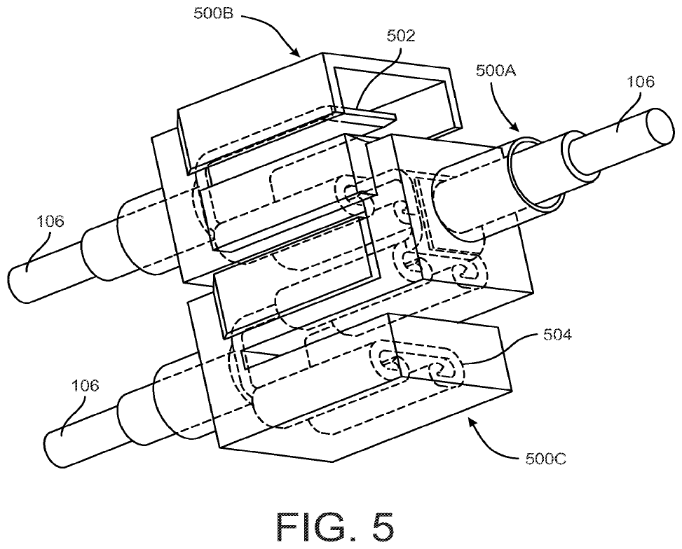

It will be appreciated that alternative contact configurations are contemplated herein. For example, a similar scheme may be practiced with medial biased and medial side contact contacts. According to such a configuration, the medial sides of the contacts may contact each other. Additionally, according to such a configuration, the contacts may be displaced laterally upon installation. Additionally, while FIG. 3 illustrates hermaphroditic and substantially identical wiping contacts, additional alternative configurations are contemplated herein, and some configurations are discussed below (e.g., see FIG. 5).

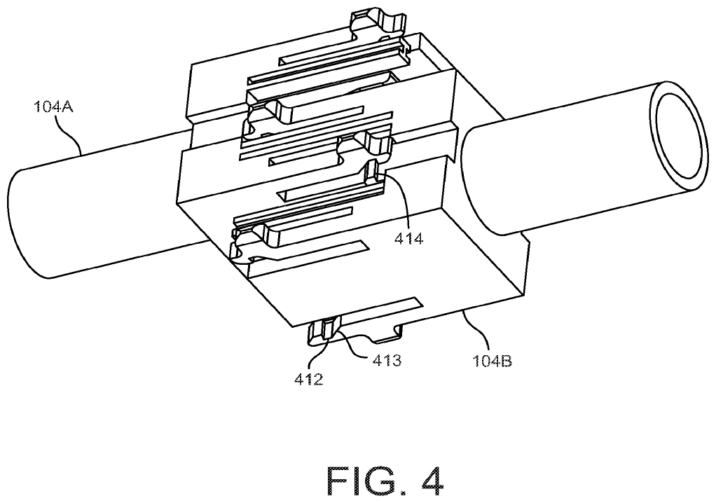

FIG. 4 illustrates two example installed connectors 100A and 100B according to one or more aspects of the present disclosure. Referring to FIG. 4, each housing 104 may include longitudinal retention features restricting the installed housings from sliding apart. The longitudinal retention features may restrict the relative movement of the two installed connectors. Longitudinal movement may be understood as movement in the direction of the stems. Longitudinal retention features may include latching features of complementary geometry.

More particularly, As shown in FIG. 4, each housing 104 includes one or more first latching features 412 and one or more second latching features 414 having a complementary geometry to the first latching features 412. In this example, the first latching features 412 may be considered a receiving (e.g., accepting, accommodating) latching feature, while the second latching feature 414 may be considered the received latching features. As illustrated, the first latching feature 412 is an elastically deflectable tab having a catch 413 while the second latching feature 414 is a protrusion that deflects the tab and retains the catch 413 when fully inserted. The example latching features 412 and 414 are configured such that when two example installed connector housings 104A and 104B are installed, the latching features 412 and 414 engage one another to oppose relative movement of the two installed electrical connectors with respect to each other in at least one direction (e.g., the relative longitudinal movement of the two installed electrical connectors).

The example latching features 412 and 414 may be designed and configured such that the latching features 412 and 414 may disengage if the two installed connectors are pulled in the opposing longitudinal directions with sufficient force. The sufficient force may be designed for according to considerations (e.g., safety considerations, ease of installation and uninstallation considerations, etc.). Additional and or alternative latching features may be used (e.g., latching features that require physical disengagement before uninstallation) as would be understood by persons of ordinary skill in the art. While FIG. 4 illustrates the longitudinal retention features as latching features 412 and 414, it may be understood by persons of ordinary skill in the art that electrical connectors and housings 104 may be configured to resist longitudinal movement. For example, the housings 104 may utilize internal latching features on the inside side of the housing. Additionally or alternatively, where robust retention is desired, the housings may be longitudinally retained with one or more screws in the housings. Any method of retaining such bodies as known to those of ordinary skill in the art are contemplated herein.

Referring again to FIG. 1, the housing 104 may electrically insulate (e.g., separate) the conductive body from the surroundings of the connector around at least a portion of the conductive body 102. Accordingly, the connectors may be configured such that they may be safe to touch and leave in electrical boxes (e.g., in gang/junction boxes) while electrically connected and energized. The housings 104 and/or the electrical connector 100 may be configured to conform to one or more various electrical safety standards, for example, safe-to-touch standards and/or standards that may comply with one or more of, for example, National Electrical Code (NFPA 70), the International Electrotechnical Commission (IEC), Underwriters Laboratories (UL) (e.g., UL “finger test”), Conformite Europeenne (CE), or any other electrical safety standard.

The housing 104 may be opened at its top side (e.g., distally situated) to be able to accept the installation of additional electrical connectors 100. While FIG. 1 illustrates the sides of the housing 104 as including gaps in the housing material, it may be appreciated that the housing may similarly be configured without one or more of the depicted gaps in the housing material. Such configurations would not alter the principles of the present disclosure. Additionally, the top side of the conductive body 102 may be distanced from the top side of the housing 104 and or the “outside-world.” The distance between the top side of the conductive body 102 and the housing 104 may vary depending on configuration, for example, based on one or more of the standards as mentioned above (e.g., standards from NFPA 70, IEC, UL, CE, etc.).

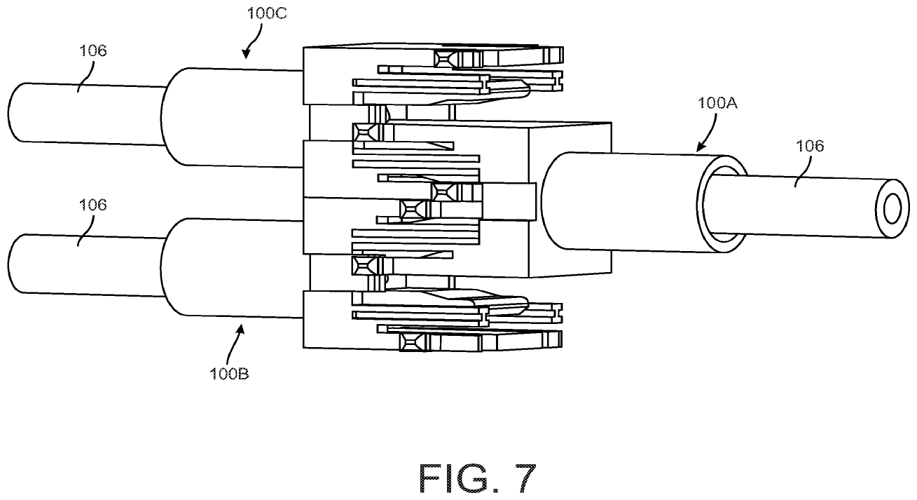

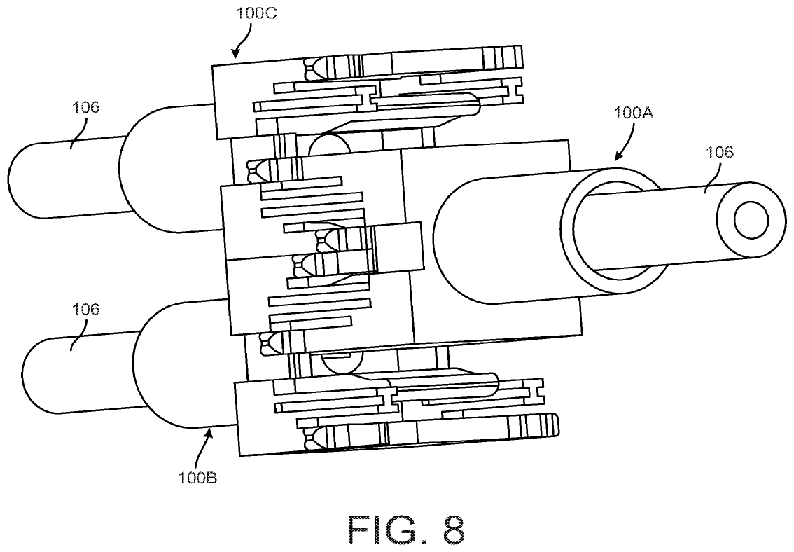

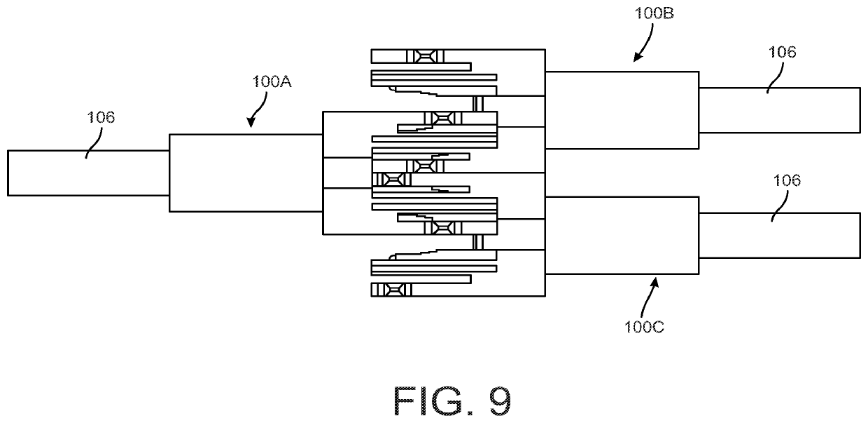

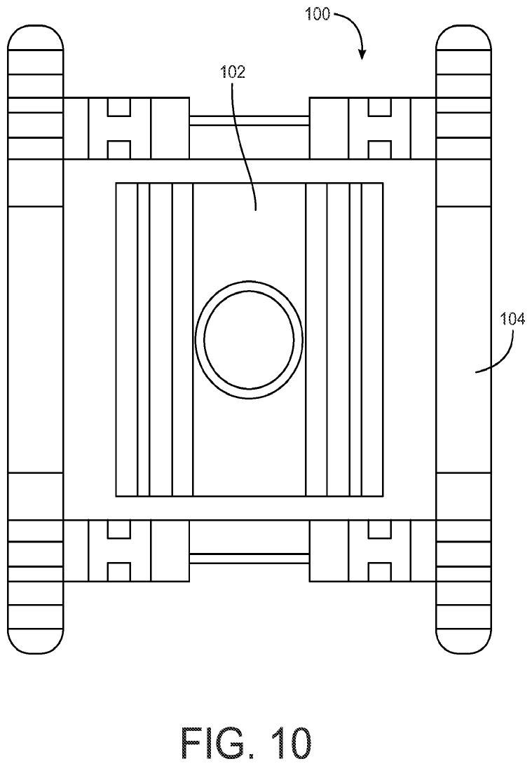

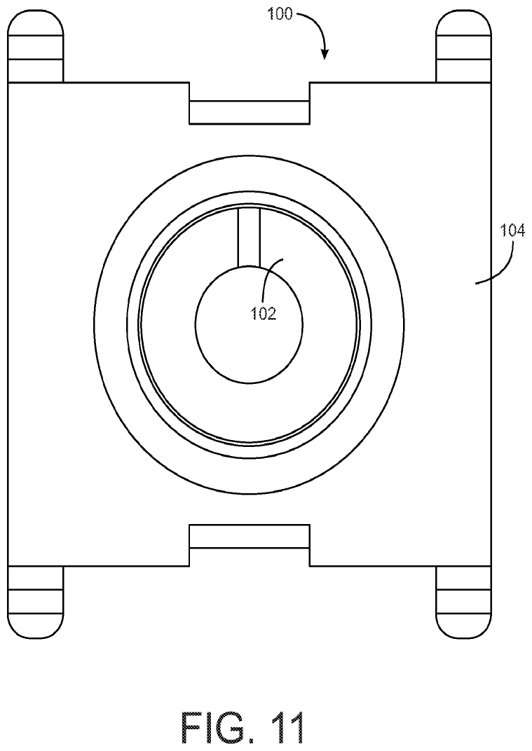

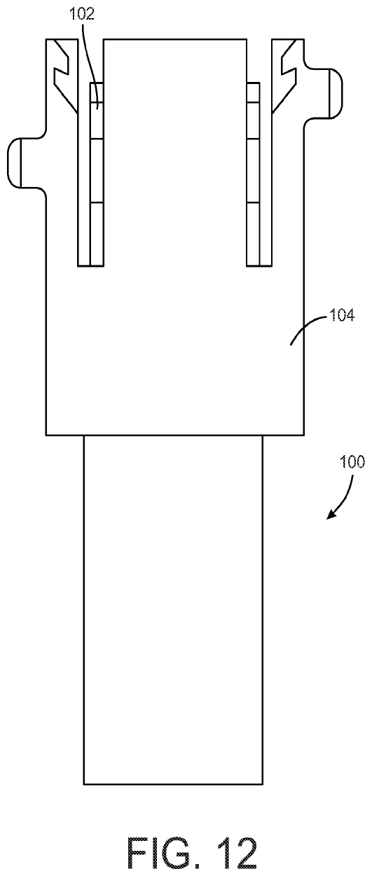

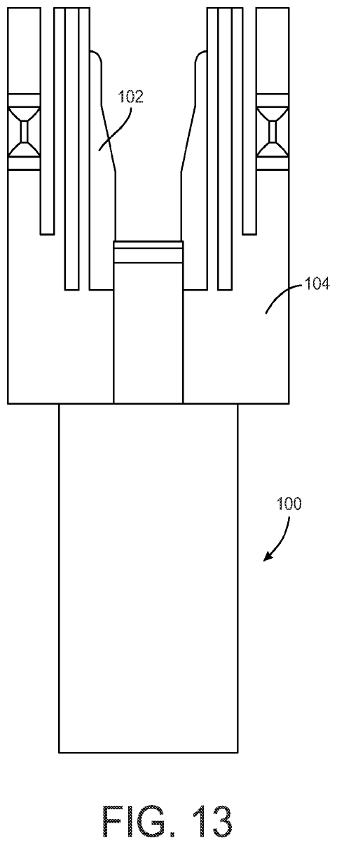

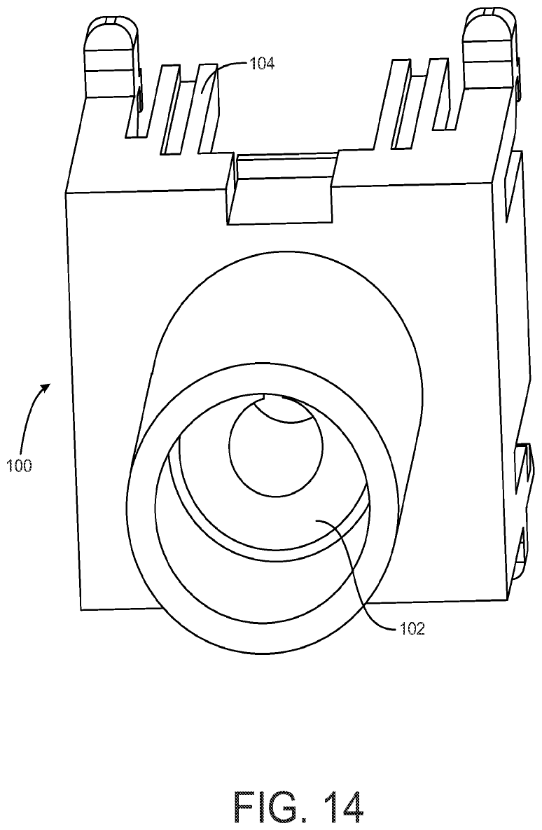

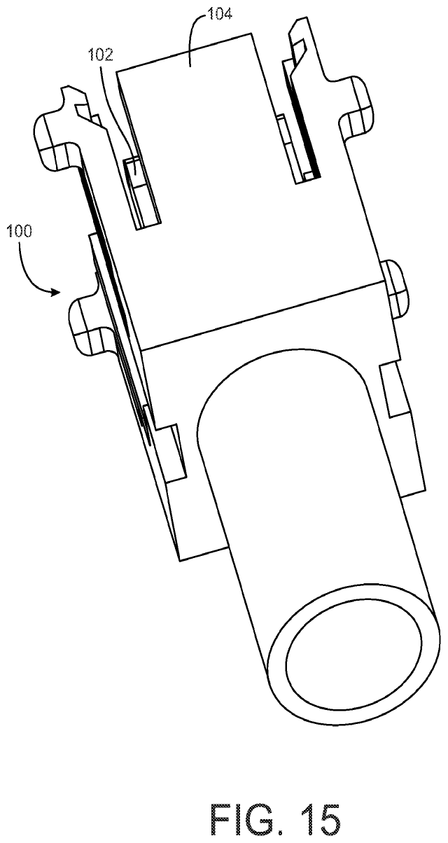

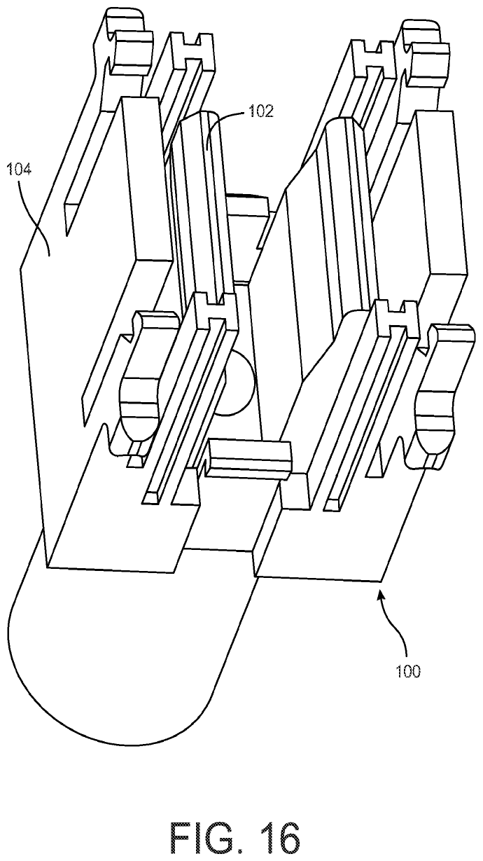

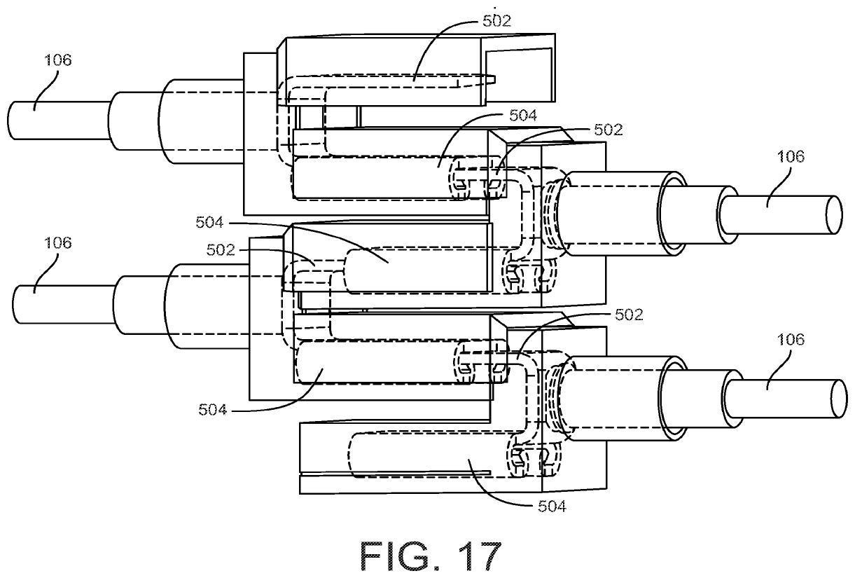

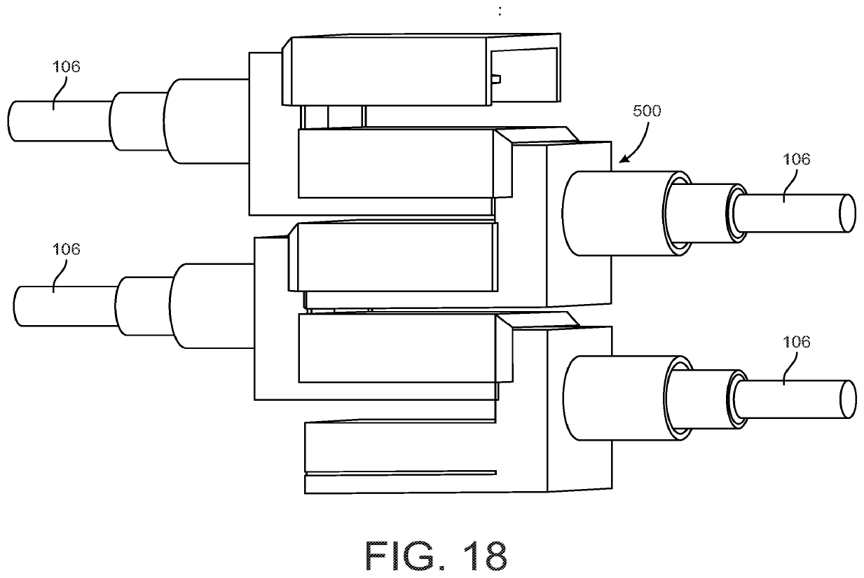

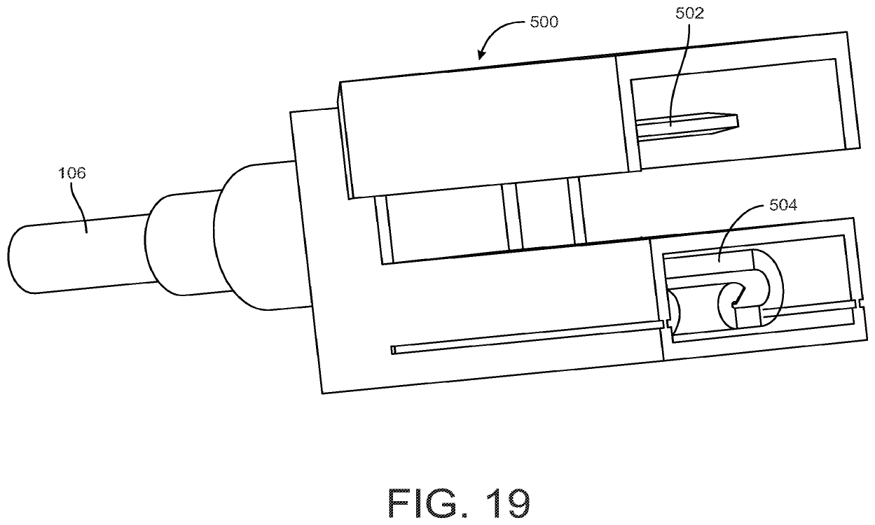

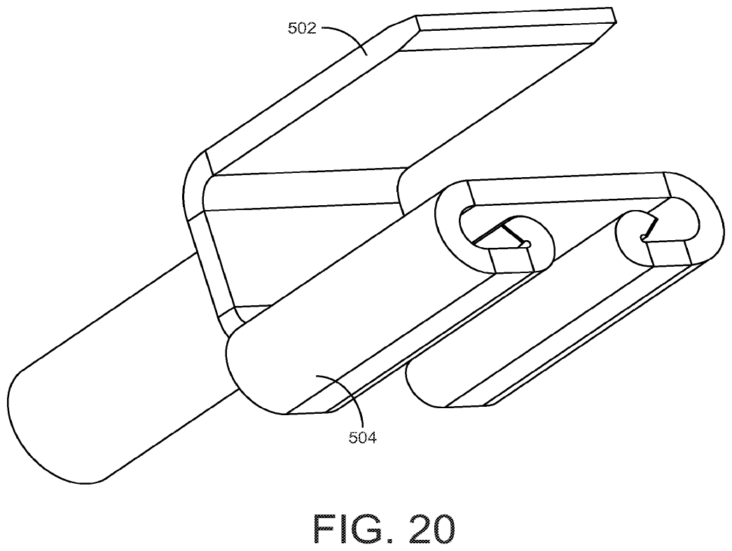

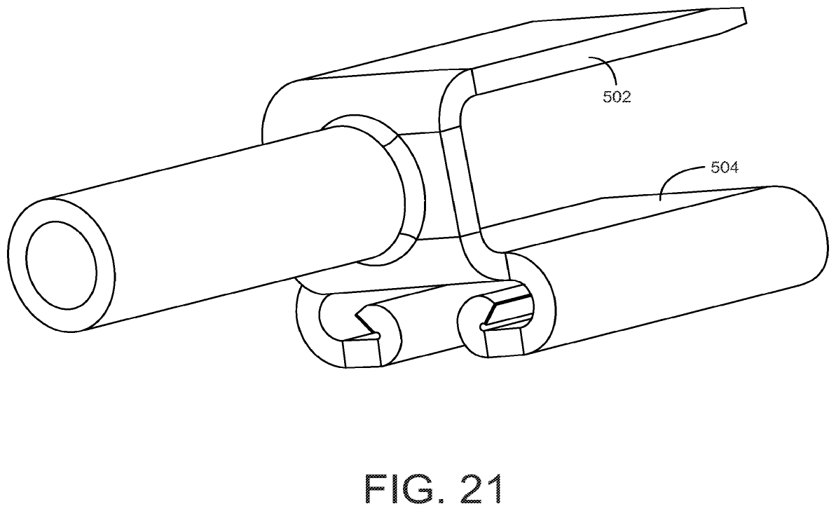

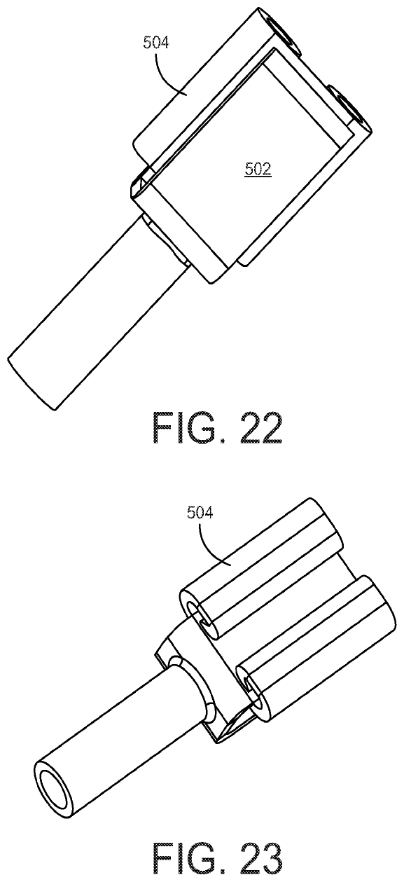

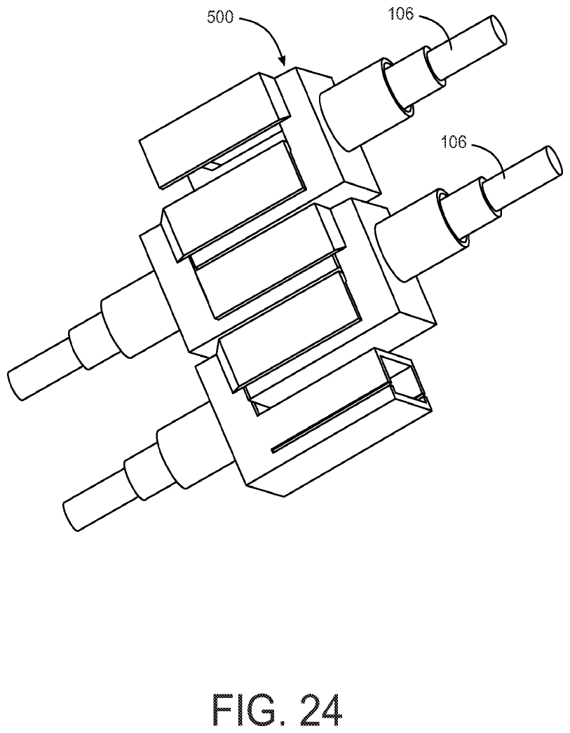

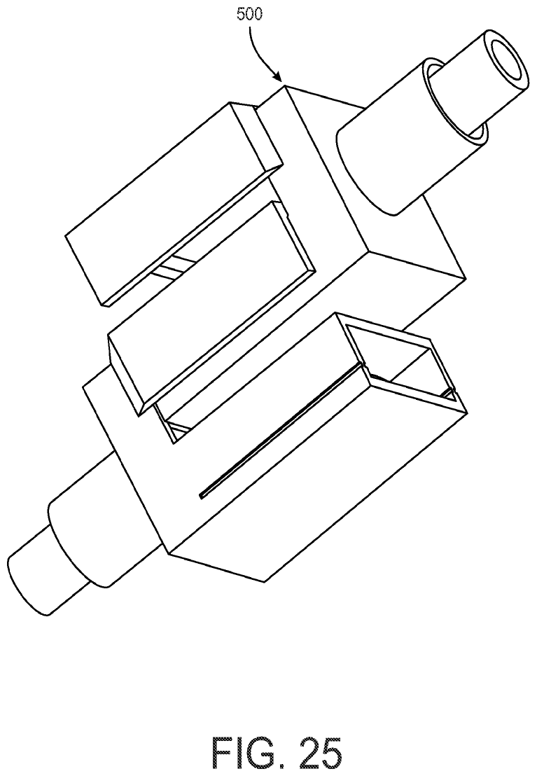

FIGS. 1-4 and 6-16 depict the illustrative electrical connector 100 as including two substantially identical wiping contacts. As described, however, the contacts may be configured in different arrangements. For example, FIG. 5 and FIGS. 17-24 illustrates a plurality of installed example plug and socket connectors 500 according to additional aspects of the present disclosure. Referring first to FIG. 5, the example plug and socket connector 500 may include two contacts, a plug contact 502 and a socket contact 504. The plug contact 502 and the socket contact 504 may be configured such that when two plug and socket connectors 500 are installed, the plug contact 502 of the first plug and socket connector 500A may insert into the socket contact 504 of the second plug and socket connector 500B. Accordingly, the first and second plug and socket connectors 500A and 500B may be electrically connected with one another.

The plug contact 502 may be substantially blade-shaped, i.e., quadrilateral shaped with a thickness. The plug may extend from a first end of the stem. The top portion of the plug may form a tapered region which may taper from a first thickness to a second thickness that is narrower than the first thickness. The tapered region may assist in inserting the plug into the socket. Though a substantially quadrilateral plug is described, the plug could take any shape (e.g., round, triangular, irregularly shaped) as would be appreciated. Whatever shape the plug takes, the socket may be configured to receive the shape of the socket.

If the plug is blade-shaped, the socket may be configured to accept a blade-shaped plug. Referring to FIG. 5, the socket contact 504 may extend from the first end of the stem, the same end as the blade. The socket may be disposed of substantially opposite the plug.

The socket may be scrolled. The plug may be mechanically configured to engage and/or fit in the scroll. The fit may be an interference fit. The mechanical fit of the plug contact 502 and socket contact 504 may assist electrical connection of the installed electrical connectors and may additionally assist in restraining the relative movement of the two electrical connectors.

While plug and socket electrical connectors 500 having blade shaped plugs and sockets of complimentary geometry, plugs, and sockets of the present plug and socket electrical connectors 500 may be shaped variously (round, square, triangular, etc.) as would be understood by persons of ordinary skill in the art.

FIGS. 1-5 depict electrical connectors with the contacts extending from the stem in a direction away from the conductor that may be attached to the stem. The present disclosure may similarly be practiced with contacts that extend from the stem in the direction of the conductor that may be attached to the stem. For example, a conductor may be inserted and connected to the stem at a first end of the stem. The contacts may extend from the first and or second end of the stem and may each extend in a lateral direction from the stem. Each contact may then extend in the direction back toward the stem (i.e., in the direction opposite to the direction of contact extension depicted in FIGS. 1-5.

FIGS. 6-25 depict additional views and configurations of example electrical connectors, and/or parts thereof, of the present disclosure. Additional aspects of the present disclosure may be clarified and or understood with reference to FIGS. 6-24.

It is further contemplated herein that electrical components and/or devices/appliances (e.g., outlets, switches, etc.) may include a complementary connector to accept an electrical connector of the present disclosure. For example, the electrical component (e.g., outlet) may include one or more areas of connection that may correspond to the electrical connectors of the present disclosure. Accordingly, the electrical connector (and conductor to which the electrical connector may be attached) may be simply physically and electrically connected to the electrical component by plugging the connector into the component.

Additionally, a double-sided universal connector is contemplated herein. Such a double-sided connector may include two sides having connector configuration as described herein. For example, Referring to FIG. 1, the side of the connector that may be configured to accept a conductor may be replaced by additional contacts (e.g., substantially similar to conductive contacts described herein). Accordingly, the double-sided connector may be used to increase the configurability of electrical connection utilizing aspects of the present disclosure.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

We claim:

1. An electrical connector comprising:
a conductive body comprising:
a stem; and
a first contact and a second contact extending from the stem, the first contact configured to electrically contact a first different contact of a first another electrical connector, and the second contact configured to electrically contact a second different contact of a second another electrical connector; and
a housing including an insulating material and being configured to enclose at least a portion of the conductive body and to electrically insulate the enclosed portion of the conductive body such that the electrical connector is configured to be installed and detached from the another electrical connector even while electric charge is present.

2. The electrical connector of claim 1, wherein the first contact is substantially identical to the second contact, and wherein the first contact and the second contact are substantially mirrored about a center plane of the conductive body.

3. The electrical connector of claim 1, wherein the stem comprises a orifice configured to receive a conductive wire.

4. The electrical connector of claim 3, wherein the stem is further configured to be coupled with the conductive wire by at least one of crimping, soldering, fastening, welding, set-screwing, ultrasonically welding, insulation displacement contacting, or pressure connecting.

5. The electrical connector of claim 1, wherein each of the first contact and the second contact comprises a lateral side and a medial side and each of the first contact and the second contact extends from the body and is biased laterally, such that when the electrical connector is installed with the first another electrical connector, the lateral side of the first contact and the lateral side of the first different contact press against one another by virtue of the lateral bias.

6. The electrical connector of claim 1, wherein each of the first contact and the second contact is hermaphroditic and comprises substantially identical wiping contacts.

7. The electrical connector of claim 1, wherein the first contact is mechanically configured to be a plug and the second contact is mechanically configured to be a socket of complementary configuration to the plug such that when the electrical connector is installed with the first another electrical connector, the plug contact of the electrical connector mechanically fits with a socket of the first another connector.

8. The electrical connector of claim 7, wherein when the electrical connector is installed with the second another electrical connector, a plug contact of the second another electrical connector mechanically fits with the socket of the electrical connector.

9. The electrical connector of claim 1, wherein the housing comprises a longitudinal retention feature and a lateral retention feature.

10. The electrical connector of claim 9, wherein the longitudinal retention feature comprises latching geometry that restricts, in a longitudinal direction, relative motion of the electrical connector with at least one of the first another electrical connector or the second another electrical connector.

11. The electrical connector of claim 9, wherein the lateral retention feature comprises at least one track that restricts, in a lateral direction, relative motion of the electrical connector with at least one of the first another electrical connector, or the second another electrical connector.

12. The electrical connector of claim 11, wherein, when the electrical connector is installed with the first another electrical connector the at least one track of the electrical connector engages a corresponding track of the first another electrical connector.

13. The electrical connector of claim 1, wherein the housing comprises a stem housing portion enclosing at least a position of the stem of the conductive body.

14. A universal connector system comprising:
a first electrical connector comprising:
a first conductive body comprising:
a first stem;
a first contact extending from the first stem at a first end thereof and proximate to a first side thereof; and
a second contact extending from the first stem at the first end thereof and proximate to a second side thereof substantially opposed to the first side thereof; and
a first insulator housing enclosing a portion of the first conductive body and configured to engage at least one other housing; and
a second electrical connector substantially identical to the first electrical connector comprising:
a second conductive body comprising:
a second stem;
a third contact extending from the second stem at a first end thereof and proximate to a first side thereof such that when the first electrical connector and second electrical connector are installed together, the first contact electrically contacts the third contact effecting an electrical connection between the first conductive body and second conductive body; and
a fourth contact extending from the second stem at the first end thereof and proximate to a second side thereof substantially opposed to the first side thereof; and
a second insulator housing enclosing at least a portion of the second conductive body and configured to such that when the first electrical connector and the second electrical connector are installed together, the first insulator housing engages the second insulator housing.

15. The universal connector system of claim 14, wherein the first stem comprises a first orifice configured to receive a first conductive wire and wherein the second stem comprises a second orifice configured to receive a second conductive wire such that when the first electrical connector and the second electrical connector are installed together, the first conductive wire is electrically connected to the second conductive wire via the first electrical connector and the second electrical connector.

16. The universal connector system of claim 14, further comprising a third electrical connector substantially identical to the first electrical connector and the second electrical connector comprising:
a third conductive body comprising:
a third stem;
a fifth contact extending from the third stem at a first end thereof and proximate to a first side thereof such that when the first electrical connector, the second electrical connector, and the third electrical connector are installed together, the second contact electrically contacts the fifth contact effecting an electrical connection between the first conductive body, the second conductive body, and the third conductive body; and
a sixth contact extending from the third stem at the first end thereof and proximate to a second side thereof, substantially opposed to the first side thereof; and
a third insulator housing enclosing at least a portion of the third conductive body and configured such that when the first electrical connector, the second electrical connector, and the third electrical connector are installed together, the first insulator housing engages the second insulator housing and the third insulator housing.

17. A universal connector system comprising:
a plurality of substantially identical electrical connectors engaged with each other, each of the plurality of substantially identical electrical connectors configured to engage with and electrically connect to a first engaged electrical connector and a second engaged electrical connector, each of the plurality of substantially identical connectors comprising:
a conductive body comprising:
a stem;
a first contact extending from a first end of the stem and configured to electrically contact a first another contact of the first engaged electrical connector; and
a second contact extending from the first end of the stem and configured to electrically contact a second another contact of the second engaged electrical connector; and
a housing enclosing at least a portion of the conductive body.

18. The universal connector system of claim 17, wherein the housing of each connector is further configured to engage the housing of the first engaged electrical connector and the second engaged electrical connector to restrict, in a longitudinal direction, relative motion of the electrical connector and the first engaged electrical connector and the second engaged electrical connector.

19. The universal connector system of claim 17, wherein the housing of each connector is further configured to engage the housing of the first engaged electrical connector and the second engaged electrical connector to restrict, in a lateral direction, relative motion of the electrical connector and the first engaged electrical connector and the second engaged electrical connectors.

20. An electrical connector comprising:
a conductive body comprising:
a stem; and
a first contact and a second contact extending from the stem, the first contact being mechanically configured to be a plug and to contact a first different contact of a first another electrical connector, the second contact being mechanically configured to be a socket of complementary configuration to the plug and to electrically contact a second different contact of a second another electrical connector; and
a housing including an insulating material, the housing being configured to enclose at least a portion of the conductive body and electrically insulate the enclosed portion of the conductive body such that the electrical connector is configured to be installed and detached from the first another electrical connector even while electrical charge is present.
